(19) United States
(12) Patent Application Publication
(10) Pub. No.: US 2022/0325619 A1
(43) Pub. Date: Oct. 13, 2022

(54) EGS MAGNETIC NANOPARTICLE TRACER AGENT TECHNIQUE AND INTERPRETATION METHOD

(71) Applicant: Institute of Geology and Geophysics, Chinese Academy of Sciences, Beijing (CN)

(72) Inventors: Yanlong Kong, Beijing (CN); YAQIAN REN, Beijing (CN); CHANGQIAN CAO, Beijing (CN); WEI SONG, Beijing (CN); YUANZHI CHENG, Beijing (CN); YONGHUI HUANG, Beijing (CN)

(21) Appl. No.: 17/217,208

(22) Filed: Mar. 30, 2021

(51) Int. Cl. E21B 47/11; F24T 10/20; E21B 43/26

(52) U.S. Cl. CPC E21B 47/11; F24T 10/20; E21B 43/26; F24T 50/00

(57) ABSTRACT

The disclosure provides an Enhanced Geothermal System (EGS) magnetic nanoparticle tracer agent technique and interpretation method. The method comprises the steps of: through a magnetic nanoparticle surface modification technique and thermal stability analysis of a high-temperature high-pressure reactor, firstly accomplishing the screening of magnetic nanoparticles, so as to prepare magnetic nanoparticles having suitable diffusivity and controllable thermal stability; upon this basis, performing a core penetration test, characterizing EGS connectivity by sampling and analyzing the change in concentration of magnetic nanoparticles, and calculating a heat exchange area between rock and injected water; and meanwhile obtaining electromagnetic signal distribution of magnetic nanoparticles entering a reservoir by utilizing an electrical measurement technology, inverting reservoir connectivity by using resistivity and calculating the heat exchange area, and calibrating the resulting reservoir connectivity and heat exchange area with the connectivity.

### TECHNICAL FIELD

The disclosure belongs to the technical field of deep underground reservoir heat storage engineering, and particularly relates to an enhanced geothermal system (EGS) magnetic nanoparticle tracer agent technique and interpretation method.

### BACKGROUND

Geothermal energy is a renewable energy which is clean, low in carbon, wide in distribution, rich in resources, safe and stable, and plays an important role in the development of clean energy in the future. An Enhanced Geothermal System (EGS) is a geothermal system which is capable of economically extracting deep thermal energy from a low-permeability rock body through artificial heat storage. The geothermal resources based on the EGS technology have very huge quantities, which are regarded as the future of geothermal energy in the industry, are the international frontier and an emerging hot spot for geothermal resources researches, and will occupy a decisive position in the future geothermal energy development and thermal energy storage.

A tracer agent, as an inevitable key technique for EGS, is used for researching the fracture connectivity, estimating the fracture density generated by fracture and calculating the heat exchange area. The fracture connectivity and the fracture volume generated by pressure can be obtained based on a penetration curve of a single tracer agent by calculating the recovery rate, average retention time, flow rate and other parameters, which is relatively common. However, calculation of the heat exchange area between injected water and rock after fracture is relatively difficult, which is one of important technical challenges faced by EGS. The principle for calculation of the heat exchange area between injected water and rock is as follows: a tracer agent with strong adsorptivity and a tracer agent with strong diffusivity are selected for tracer agent test, penetration curves when there are significant difference between peaks and trailers are obtained, and the heat exchange are obtained through fitting by virtue of quantitative description of a mathematical physical equation. To obtain the heat exchange area, except the tracer agent is “traditionally” required for low background value, easy detection, environmental friendliness and low price and the like, the following two conditions must met: one is use of at least two tracer agents; the other is that there is sufficient difference for diffusivity within tracer agent time.

The tracer agent typically includes a natural tracer agent (environment isotopes, ions dissolved in water and gas components, etc.) and an artificial tracer agent (coloring agents, man-made isotopes and sodium fluorescence, etc.). Each tracer agent has its own advantages and disadvantages. The natural tracer agent, taking water isotopes 180 and 2H as examples, serves as components of a water molecule, which is used for determining a reaction process between water and rock and even identifying a water flow path, however, since a raw water recharge tank is used in the process of exploiting geothermal energy, it cannot be used for artificially transforming fracture evaluation after heat energy storage. The artificial tracer agent, such as sodium fluorescein, can be used for tracing the transport of the water recharge tank, but its adsorptivity and diffusivity are not controllable, and meanwhile a situation of high background value occurs; furthermore, since sodium fluorescein has a limited wavelength detectable range, it will cause its diffusion is difficult. Starting from the property of the tracer agent, typically, the tracer agent can also be divided into a conserved tracer agent and a reactive tracer agent, among them, the conserved tracer agent is transported with the solution and does not react with rock; the reactive tracer agent reacts with rock (or self) during the transport. However, as the intrinsic diffusivities of these traditional tracer agents are not easy to artificially control, under the low-permeation condition of EGS, it is difficult to realize significant penetration curve peak difference and trailer difference so as to cause a fact that the heat exchange area cannot be calculated.

In recent years, more attentions are paid to a novel nanoparticle tracer agent, due to good water solubility and controllable diffusivity. But, there are still two key problems in the aspect of application of nanoparticle tracer agent technologies: one problem is high monitoring cost, and the drilling cost of a monitoring well and the monitoring cost of tracer agent sampling are both extremely high; the other problem is that the thermal stability of nanoparticles is unknown, it is possible to coagulate under the conditions of high temperature and high pressure to lead to a fact that the tracer agent goal is difficult achieved.

Evaluation of the heat exchange area of EGS using a tracer agent technique is one of important indexes for measuring its heat exchange effect. However, due to being limited by a fact that the traditional tracer agent is difficult to artificially control, the novel tracer agent has high monitoring cost and unknown thermal stability and adsorptivity, which are key difficulty for evaluating the heat exchange area. Therefore, it is necessary to develop a new tracer agent, especially a diffusivity-controllable tracer agent.

### SUMMARY

The objective of the disclosure is to provide an EGS magnetic nanoparticle tracer agent technique and interpretation method.

The disclosure is achieved through the following technical solution:

The disclosure relates to an EGS magnetic nanoparticle tracer agent technique and interpretation method, comprising the following steps:

Step 100, accomplishing selection and preparation of a magnetic nanoparticle tracer agent by using magnetic nanoparticle surface modification technique and high-temperature high-pressure thermal stability analysis;

Step 200, performing an indoor core penetration test by using three tracer agents namely a magnetic nanoparticle tracer agent prepared in Step 100, a conserved tracer agent NaCl and a reactive tracer agent Safraine T, detecting an electromagnetic signal using an exciting electrode, performing inversion calculation on a real component, an imaginary component and polarizability of complex resistivity, and then calculating the porosity of the core;

Step 300, characterizing EGS connectivity by sampling and analyzing the change in concentration of magnetic nanoparticles, obtaining penetration curves of different peaks and trailers through a tracer agent test, respectively fitting the penetration curves using a mathematical model, and constructing a fracture solute transport model;

Step 400, obtaining electromagnetic signal distribution of magnetic nanoparticles entering into a reservoir by utilizing an electrical measurement technology, and inverting the reservoir connectivity by using resisitivity; and

Step 500, comparing resisitivity distribution detectiond outside the core with the penetration curve observed by sampling, comprehensively inverting the reservoir connectivity and calculating the heat exchange area.

Preferably, the Step 100 specifically comprises the following steps: the magnetic nanoparticles modified by a surface modifying agent are placed in a high-temperature high-pressure reactor, field stable temperature-pressure conditions of an EGS are given, concentration change and experience change of a magnetic nanoparticle tracer agent solution are measured so as to obtain a change relationship depending on temperatures and pressures, thereby screening an optimal surface modifying agent.

The surface modification of the magnetic nanoparticles: different magnetic nanoparticle coating materials (copolymers of sulfurized polystyrene and malonic acid, SiO₂ and heat-resistant ferritin, etc.) are used, and the particle size of the coating material is adjusted so that its diffusivity is artificially controlled, and its particle size distribution is measured to prepare magnetic nanoparticles with different diffusivities. The prepared magnetic nano tracer agent solution is placed into a high-temperature high-pressure reactor. By referring to prepared wild geological conditions, the concentration change and particle size change of magnetic nanoparticle solution are measured to obtain a change relationship of concentrations of magnetic nanoparticles over temperature and pressure, thereby screening the most proper surface modifying agent.

The screening steps are as follows:

Step 101, surface modification of magnetic nanoparticles, namely, preparing a certain concentration of copolymer (PSS-co-MA) solution of sulfonated polystyrene and propandioic acid, SiO₂ modified magnetic nanoparticles and magnetic ferritin nanoparticles;

Step 102, stable-pressure sensitivity analysis, namely, designing a high-temperature high-pressure reactor test, analyzing a change relationship of particle sizes depending on temperatures and pressures, and initially selecting magnetic nanoparticles meeting performances; and

Step 103, selection of high-temperature high-pressure diffusivity, simulating reservoir conditions, displacing a tracer agent through high pressure, and determining influences of different surface modifying agents on adsorptivity and diffusivity of magnetic nanoparticles in pores through a high-pressure displacement tracer agent, thereby preferably selecting high-diffusivity magnetic nanoparticles as an ideal tracer agent.

The principle of Step 100 is as follows: reservoir conditions are simulated, and magnetic nanoparticles are displaced through high pressure, so that the influence of different surface modifying agents on the adsorptivity and diffusivity of magnetic nanoparticles in pores is determined, and high-diffusivity magnetic nanoparticles are preferably selected as the ideal tracer agent; the diffusivity of the magnetic nanoparticles is controllable at high temperature and high pressure, which is a key for EGS tracer agent test; the indoor test is performed, and the proper surface modifying material is screened to ensure that the thermal stability, diffusivity and adsorptivity of the nanoparticles are controllable.

Preferably, the Step 200 specifically comprises the following steps: the tracer agents NaCl and Safraine T and a magnetic nanoparticle tracer agent are monitored in real time respectively using an induced polarization imaging method, the change in an imaginary part of complex resistivity of the core over time is calculated, the change is compared with a penetration curve result to analyze a core penetration test result test, penetration time and fracture volume are calculated, the fracture aperture, diffusivity and core porosity parameters are given in a fracture solute transport model, the penetration curves of different peaks and trailers are fit, and heat exchange areas are calculated.

The involved NaCl tracer agent is measured through ion chromatography, Safraine T tracer agent is measured by a spectrophotometer, and the magnetic nano tracer agent is measured through mass spectrometer and a high-resolution transmission electron microscope.

More further, in the Step 200, indoor core penetration test is performed using three tracer agents, such as the prepared magnetic nanoparticle tracer agent and the conserved tracer agent NaCl and the reactive tracer agent Safraine T, which specifically comprises the following steps:

Step 201, before test, the core from the selected reservoir is pressed to form fractures;

Step 202, the core is rinsed with deionized water to remove any fine mineral particles that may subsequently cause plugging, and then the core is placed into a pressure container outside which a constant-temperature heating device with a thermal insulation material layer is covered for sealing. Meanwhile, three tracer agent solutions are prepared to be placed in a tracer agent storage box;

Step 203, the test is started, an air pump is opened so that the pressure container is kept negative pressure, and the air pump and a branch valve are closed after the tracer agent enters the core. The pressure parameters of a backpressure regulator are set and pressurization parameters are set so that the pressure not only meets the requirement of the pressure container but also is lower than the set pressure of the back pressure regulator. A high-pressure constant-flow pump is opened to pressurize the pressure container while setting a heating temperature, the constant-temperature heating device is opened to heat the pressure container, and the temperature and pressure values in the container are confirmed by using a temperature sensor and a pressure gauge. After keeping the balance for a period of time, the pressure parameters of the back pressure regulator are set to be less than the pressure parameters of the pressure container. In such way, the tracer agent flows slowly to the partial pressure end of the backpressure regulator in the system, and the effluent is collected regularly at the tracer agent collection place.

Step 204, in the process of performing the core penetration test with three tracer agents, exciting electrodes (Ag—AgCl) are arranged at entrance and exit ends of the core, while receiving electrodes (non-polarized electrode Ag—AgCl) are arranged at equal intervals on the core surface (Wenner device).

Step 205, in the process of monitoring the electromagnetic signal, the phases and amplitude data under different frequencies are measured, and the real component, virtual component and polarizability of complex resistivity are calculated by the Marquette inversion method.

Step 206, based on the resistivity value obtained by inversion, the porosity of the core is calculated according to the modified Archie formula.

Preferably, in the Step 200, the penetration time and the fracture volume are calculated according to the test results obtained from an indoor core penetration test, the fracture aperture, diffusivity, core porosity and other parameters are given in the fracture solute transport model, the penetration curves of different peaks and trailers are fit, and the heat exchange areas are calculated.

Preferably, in the Step 200, the inversion calculation is specifically as follows: the medium connectivity is calculated by using the electromagnetic signal, the resistivity distribution detected outside the core is compared with the penetration curve obtained by sampling observation to integrate the inverted reservoir connectivity and calculate the heat exchange area of injected water and rock.

Preferably, in the Step 300, EGS connectivity is characterized by sampling and analyzing the change in concentration of magnetic nanoparticles, penetration curves of different peaks and trailers are obtained through a tracer agent test, the penetration curves are respectively fit using a mathematical model. For the mathematic model of the tracer agent in the transmission and transport process of the fracture medium, it is needed to construct a solute transport model is constructed by comprehensively considering the flow of fluid in the fracture medium, the heat transfer in the fracture and transport process of the tracer agents.

Preferably, in the Step 400, the electromagnetic signal distribution of magnetic nanoparticles entering the reservoir is obtained by using an electrical measurement technology, the fracture connection of the reservoir is inverted by using resisitivity, the penetration curves of different peaks and trailers are obtained, the average tracer agent residence time, tracer agent recovery ratio, fluid transport rate and other parameters are calculated, the stimulation result of the fracture solute transport model is demarcated, and the flowing path and permeability of the fluid are evaluated.

According to the electrical measurement technology, is used to test the resistivity and electromagnetic signal distribution are tested through two apparatuses namely portable complex resistivity tester and a nuclear magnetic resonance spectroscope. Three tracer agents (NaCl, Safraine T and magnetic particles) are monitored in real time respectively using an induced polarization image technology, and the change in an imaginary part of complex resistivity of the core over time is calculated, and this change is compared with the penetration curve result for analysis.

Preferably, the Step 400 specifically comprises the following steps: real-time distribution detection of magnetic nanoparticles is realized through the electromagnetic imaging technology to reduce huge monitoring cost generated by drilling; and a new monitoring means is innovated to replace sampling observation with physical geography detection, and the heat exchange area of the reservoir is calculated through mathematic inversion. The medium connectivity is inverted by using the electromagnetic signal, the resistivity distribution detected outside the core with the penetration curve obtained by sampling observation to integrate the inverted reservoir connectivity and calculate the heat exchange area of injected water and rock, thereby providing a new technical means for future geothermal energy development.

Preferably, in the Step 400, the medium connectivity is inverted by using the resistivity, specifically, the resistivity and polarizability of the core are calculated in real time utilizing a Cole-Cole parameter inversion method of a Marquette algorithm, and the resulting resistivity and polarizability are compared with the initial resistivity and polarizability of the core, the change value of resistivity is calculated, and the porosity and permeability parameters of the core are obtained.

In the Step 500, the penetration time and the fracture volume are calculated based on core penetration test results, the fracture aperture, diffusivity, core porosity and other parameters are given in the fracture solute transport model, the penetration curves of different peaks and trailers are fit, and the heat exchange areas are calculated; the medium connectivity is inverted by using the electromagnetic signal, the resistivity distribution detected outside the core is compared with the penetration curve obtained by sampling observation to integrate the inverted reservoir connectivity and calculate the heat exchange area of injected water and rock.

Calculation of the heat exchange area is based on core physical geography real-time monitoring results, the penetration time, porosity, permeability and other parameters are calculated, the fracture aperture and diffusion coefficients are given in the fracture solute transport model, the penetration curves of different peaks and trailers are fit, and the heat exchange areas are calculated.

The material of the core pressure container is a petroleum steel pipe having a steel grade of n80, with a diameter of 50 mm and a length of 200 mm; an electric furnace wire which can be heated by electrifying is arranged in the outer ring sleeve; the outer layer of the electric furnace wire is made of glass fiber cotton which can withstand temperature of 300° C.; a special anti magnetic ring is added outside the insulation layer to resist the electromagnetic interference of the steel pipe.

The disclosure has the beneficial effects:

(1) The disclosure adopts a method of combining an indoor test and a mathematical model and meanwhile is based on the established EGS project site data, magnetic nanoparticles are used as the tracer agents, the wild geological conditions are simulated through an indoor high-temperature high-pressure reactor test, different temperatures and pressures are given, surface modifying agents with significant differences in diffusivity and adsorptivity are selected to perform surface modification on magnetic nanoparticles, and the change in particle size and diffusivity is measured, thereby selecting the surface modifying agent to solve the problems of thermal stability and adsorptivity of magnetic nanoparticles.

(2) In the disclosure, the conserved tracer agent NaCl is combined with the adsorption tracer agent Safraine T to establish an indoor test platform for tracer agent test; the medium connectivity is inverted by using the electromagnetic signal with relatively low monitoring cost, the resistivity distribution detected outside the core is compared with the penetration curve obtained by sampling observation to integrate the inverted reservoir connectivity and calculate the effective heat exchange area between injected water and rock.

(3) In the disclosure, performance exhibition of the magnetic nanoparticle as the tracer agent at high temperature and high pressure is analyzed through the indoor core penetration test, a quantitative analysis method for key production parameters such as fracture aperture, connectivity and heat exchange area is established to obtain a new understanding of the magnetic nanoparticles tracer agent technology, and a new method for explaining the fracture connectivity in the reservoir by using the electromagnetic imaging technology provides a new technical means for future geothermal energy development.

### BRIEF DESCRIPTION OF THE DRAWINGS

FIG. 1 is a flowchart of an EGS magnetic nanoparticle tracer agent technique and interpretation method provided according to the embodiment of the disclosure;

FIG. 2 is a diagram of a core penetration test device provided according to the embodiment of the disclosure;

FIG. 3 is a structural diagram of a core pressure container provided according to the disclosure;

FIG. 4 is a diagram of a magnetic nanoparticle modified by a copolymer of sulfonated polystyrene and propandioic acid, SiO₂ modified magnetic nanoparticles and magnetic ferritin;

In the drawing, reference numbers are as follows:

1—tracer agent storage tank; 2—high-pressure spray pump; 3—tracer agent pipe regulating valve; 4—injected water pipe regulating valve; 5—high-pressure constant-current pump; 6—injected water box; 7—core pressure container; 8—collector; 9—temperature sensor; 10—pressure sensor; 11 and 13—air pump pipe stop valves; 12—air pump; 14—back pressure regulating valve; 15—solution recovery pipe stop valve; 16—tracer agent solution recovery container; 17—nitrogen bottle; 18—nitigen pipe; 19—signal transmission wire; 20—tracer agent solution pipe. 701—core body; 702—pressure container; 703—constant temperature heating ring; 704—preservation layer; 705—anti-magnetic ring.

### DESCRIPTION OF THE EMBODIMENTS

Next, the disclosure will be described in detail in combination with specific examples. It should be noted that the following examples are only for further illustrating the disclosure, but the protective scope of the disclosure is not limited to the following examples.

### EXAMPLES

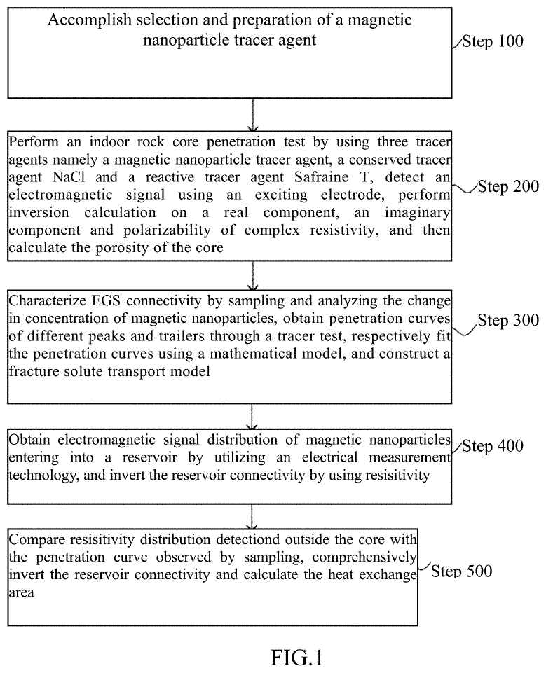

An EGS magnetic nanoparticle tracer agent technique and interpretation method provided by according to this example comprises the following steps: see in FIG. 1:

Step 100, accomplishing selection and preparation of a magnetic nanoparticle tracer agent using a magnetic nanoparticle surface modifying technology and high-temperature high-pressure thermal stability analysis;

The Step 100 specifically comprises the following steps: the surface modification of magnetic nanoparticles adopted different magnetic nanoparticle coating materials (copolymers of sulfurized polystyrene and malonic acid, SiO₂ and heat-resistant ferritin, etc.), the particle sizes of the coating materials were adjusted so that the diffusivity of the coating materials can be controlled artificially. The particle size distribution was measured to prepare magnetic nanoparticles with different diffusivities. The prepared magnetic nano tracer agent solutions were placed in the high-temperature high-pressure reactor, the change relationship of concentration of magnetic nanoparticles over temperatures and pressures was obtained, and the most proper surface modifying agent was screened.

The screening steps are as follows:

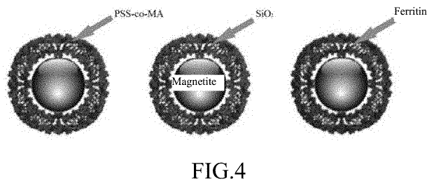

Step 101, surface modification of magnetic nanoparticles, namely, preparing a certain concentration of a copolymer (PSS-co-MA) solution of sulfonated polystyrene and propane diacid, self-assembling the copolymer solution into a cage-like structure, simulating biomimetic minerlization conditions (pH 8.5, 65° C.) of ferritin, synthesizing monodisperse magnetite (Fe₃O₄) nanoparticles in the cage of the copolymer, and removing aggregated magnetic nanoparticles through centrifugation and concentration; obtaining SiO₂ modified magnetic nanoparticles by using the same method; and by controlling the number of iron atoms entering the genetically engineered recombinant heat-resisting ferritin shell, synthesizing the magnetic ferritin nanoparticles with magnetite core through biomimetic mineralization, and controlling the particle size of the magnetic nanoparticle to be between 10 nm and 12 nm (see FIG. 4);

Step 102, stable-pressure sensitivity analysis, namely, designing a high-temperature high-pressure reactor test, setting temperatures of 90° C. 150° C. and 200° C. and the pressures of 1 Mpa, 10 MPa and 30 Mpa one by one, respectively adding the modified magnetic nanoparticle solutions modified by the different modification technique into a reactor and a displacement devices, wherein the particle size distribution of magnetic nanoparticles was measured respectively using high-resolution transmission electron microscope before and after addition, analyzing a change relationship of particle sizes depending on temperatures and pressures, wherein the surface modifying agent having the most stable particle size distribution and the least coagulation behavior was used as a magnetic nanoparticle for core penetration test; and

Step 103, selection of high-temperature high-pressure diffusivity, simulating reservoir conditions, displacing the tracer agent through high pressure, determining influences of different surface modifying agents on adsorptivity and diffusivity of magnetic nanoparticles in pores, thereby selecting high-diffusivity magnetic nanoparticles as an ideal tracer agent.

Step 200, performing an indoor core penetration test by using three tracer agents namely the magnetic nanoparticle tracer agent and the conserved tracer agent NaCl as well as the reactive tracer agent Safraine T, detecting an electromagnetic signal with an exciting electrode, performing inversion calculation on a real component, an imaginary component and polarizability of complex resistivity and then calculating the porosity of the core.

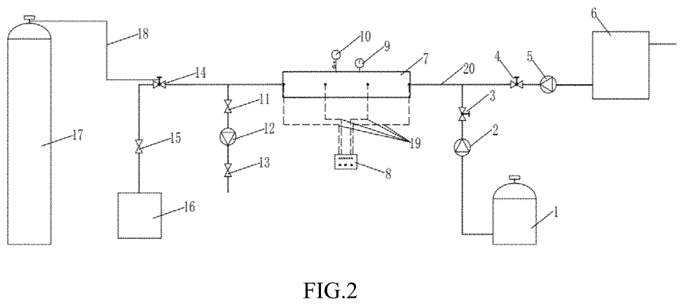

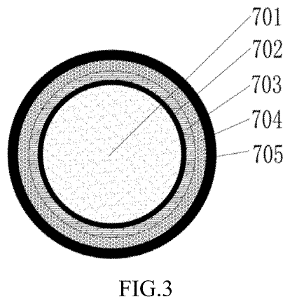

In the Step 200, the indoor core penetration test was performed by using three tracer agents namely the magnetic nanoparticle tracer agent, the conserved tracer agent NaCl and the reactive tracer agent Safraine T. The core penetration test device is as shown in FIG. 2, and the structure of the core pressure container is as shown in FIG. 3.

Step 201, before test, pressing the fractures of the core 701 of the selected reservoir sample;

Step 202, rinsing the core 701 using deionized water to remove any mineral fine particles which may subsequently cause plugging, and then placing the core into a pressure container 702, wherein a constant-temperature heating ring 703 with a thermal insulation material 704 was arranged outside the container, and an anti-magnetic ring 705 was arranged outside the thermal insulation material 704, and three tracer agent solutions were placed in a tracer agent storage box 1;

Step 203, starting the test, opening an air pump 12 so that the pressure container 7 is kept negative pressure, closing the air pump 12 and stop valves 11 and 13 after the tracer agent solution entered the core 701; setting the pressure parameters of the backpressure regulating valve 14, opening a high-pressure constant-current pump 5 to pressurize the pressure container 7, heating the pressure container 7 using the constant-temperature heating device 703, and monitoring the temperature and pressure values in the pressure container 7 using a temperature sensor 9 and a pressure sensor 10. After temperature and pressure values were stable, setting the pressure parameters of the backpressure regulating valve 14 so that the set pressure parameters were smaller than pressure parameters of the pressure container 7, allowing the tracer agent to flow back to the partial pressure end of the backpressure regulating valve 14, and collecting effluent in a tracer agent solution recovery container 16 at regular intervals.

Step 204, in the process of performing the core penetration test with three tracer agents, measurement frequency was 1-1000 Hz, 20 frequencies was selected. According to a fluid flowing-in rate, measurement time interval was selected as per min for once.

Step 205, in the process of monitoring the electromagnetic signal, phases with different frequencies and amplitude data were measured. The real component, imaginary component and polarizability of complex resistivity were calculated by using Marquette inversion method. The calculation process is as follows:

The complex resistivity of the core can be represented as ρ*=ρ′(ω)+iρ*(ω)

The complex resistivity spectrum caused by IP effect satisfies a Cole-Cole model:

$$ρ ( i ω ) = {ρ}_{0} \{ 1 - m [ 1 - \frac{1}{1 + ( i ωτ )} ] \}$$

In the formula, ρ-resistivity (excluding IP effect), ρ0-zero frequency resistivity (including IP effect), m-chargeability (polarizability), τ-time constant (unit s), c-frequency-associated coefficient.

Expressions of imaginary component, real component, phase and amplitude of complex resistivity:

$$\begin{matrix}\begin{matrix}Imaginary \\ component\end{matrix} : Im ρ ( i ω ) = \frac{- ρ ( 0 ) {m ( ωτ )}^{c} sin \frac{c π}{2}}{1 + 2 {( ωτ )}^{c} cos \frac{c π}{2} + {( ωτ )}^{2 c}} \\ \begin{matrix}Real \\ component\end{matrix} : Re ρ ( i ω ) = ρ ( 0 ) \frac{1 + ( 2 - m ) {( ωτ )}^{c} cos \frac{c π}{2} + ( 1 - m ) {( ωτ )}^{2 c}}{1 + 2 {( ωτ )}^{c} cos \frac{c π}{2} + {( ωτ )}^{2 c}} \\ Phase : ϕ ( ω ) = arc tg \frac{1 + ( 2 - m ) {( ωτ )}^{c} cos - {m ( ωτ )}^{c} sin \frac{c π}{2}}{\frac{c π}{2} + ( 1 - m ) {( ωτ )}^{2 c}} \\ Amplitude : \sqrt[ρ ( 0 )]{\frac{1 + ( 2 - m ) {( ωτ )}^{c} cos \frac{c π}{2} + ( 1 - m ) {( ωτ )}^{2 c}}{1 + 2 {( ωτ )}^{c} cos \frac{c π}{2} + {( ωτ )}^{2 c}}}\end{matrix}$$

Step 206, calculating the porosity of the core according to amended Archie equation based on the resisitivity value obtained by inversion.

The effective resistivity and porosity of fluid-containing statured rock and fluid resistor meet the following relationship formula:

$$\begin{matrix}{σ}_{eff} = {{σ}_{1} ( 1 - {χ}_{2} )}^{p} + {σ}_{2} {χ}_{2}^{m}\end{matrix} \\ Where , p = \frac{log ( 1 - {χ}_{2}^{m} )}{log ( 1 - {χ}_{2} )}$$

The porosity and permeability of the rock meet the following formula according to RGPZ model:

$${K}_{RGPZ} = \frac{{d}^{2} {φ}^{3 m}}{4 {am}^{2}}$$

Where, KPGPZ is permeability, unit: m², d is a geometrical mean of particle diameter, ϕ is porosity, m is cementation index, usually empirical constant, a is parameter constant, for a tree-dimensional geological body composed of quasi spherical particles, a=8/3.

Step 300, characterizing EGS connectivity by sampling and analyzing the change in concentration of magnetic nanoparticles, obtaining penetration curves of different peaks and trailers through a tracer agent test, respectively fitting the penetration curves using a mathematical model, and constructing a fracture solute transport model based on a mathematical model for the transfer migration process of a tracer agent in a fracture medium, it was needed to comprehensively consider the flow of the fluid in the fracture medium, heat transfer in the fracture and migration of the tracer agent.

For underground water flow in the fracture medium, stimulation was performed using simplified Navier-Stokes equation: μ∇²v=∇P−ρ_{w}g

Where, μ is fluid viscosity coefficient, v is fluid velocity, p is pressure, ρ_{w} is the fluid density. Meanwhile, a mass conservation equation of fluid is combined:

$${v}^{\text{?}} \cdot ( {ρ}_{w} b ( v ) ) = {\sum }_{1} {\dot{m}}_{1} δ ( r - {r}_{i} )$$

$$\text{?} \text{indicates text missing or illegible when filed}$$

Where, b represents the aperture of the fracture, and the right item of the equation represents a source and sink term flowing through the fracture. Combined with the above two sets of equations and Poiseuille's fluid law, we can obtain a main governing equation of fluid flow in the fracture medium:

$$- ∇ \cdot ( \frac{{ρ}_{w} {w}^{3}}{12 μ} ∇ P ) = {\sum }_{1} {\dot{m}}_{1} δ ( r - {r}_{i} )$$

This equation is solved to obtain the distribution of a pressure field of a fracture flow field, and the distribution of a velocity field can be obtained by substituting the simplified Navier-Stokes equation to solve the migration of the tracer agent below. To describe the influence of temperature change, it is necessary to consider an energy conservation equation based on the flow field so as to describe the heat transfer process in the fracture medium:

$${ρ}_{w} {c}_{w} b \frac{\partial T}{\partial t} + {ρ}_{w} {c}_{w} b 〈 v 〉 \cdot ∇ T - {k}_{w} b {∇}^{2} T = {q}_{s}$$

Where, c_{w} and k_{w} represent the heat capacity and thermal conductivity of fracture fluid respectively, and represent heat exchanged between a fracture surface and a rock matrix. The heat transfer process in the rock matrix can be solved by the following energy conservation equation:

$$\frac{\partial ( {H}_{t} )}{\partial t} = - ∇ ( {ρ}_{L} {h}_{L} {v}_{L} ) + ∇ ( λ ∇ T ) + {Q}_{heat}$$

Where, h_{L} is enthalpy of liquid phase, λ is the heat conductivity coefficient, Qₕₑₐₜ is the source and sink of heat, Hₜ is the total enthalpy in the system, including the contributions of fluid and rock:

Hₜ=ϕρ_{L}h_{L}+(1−ϕ)ρ_{R}c_{pR}T

Where, ρ_{R} is the density of rock, c_{pR} is the specific heat capacity of rock. On the basis of the flow field and heat transfer field in the fracture medium obtained above, the flow of the tracer agent in the fracture medium is further solved. Based on the mass conservation equation of the tracer agent in the fracture medium, we can establish the main flow control equation of the tracer agent:

$${\frac{\partial C}{\partial t} + 〈 v 〉 ∇ C - ∇ \cdot ( {D}_{t} \cdot ∇ c ) - \frac{{ϕ}_{m}}{b} {D}_{m} ∇ {C}_{m} \vert}_{Z = b} = 0$$

Where, C is the concentration of the tracer agent in the fracture, D is the diffusion coefficient of the tracer agent in the fracture, and v is the flow rate of solute in the fracture, which can be obtained by solving the flow field of the fracture medium described above. Cm is the concentration of solute in the rock matrix, Dm is the diffusion coefficient of solute in the rock matrix. The following control equation can be established and solved by the diffusion of the tracer agent in the rock matrix:

$$\frac{\partial {C}_{m}}{\partial t} - {D}_{m} \frac{{\partial }^{2} {C}_{m}}{\partial {y}^{2}} = 0$$

The whole solution of the mathematical model is discretized in space using a Galerkin finite element method and in time using an Euler difference method. Based on a global implicit coupling algorithm, the nonlinearity of the coupling equation is handled using Newton Raphson method, and SparseLU is directly used to solve a sparse matrix.

Step 400, obtaining the electromagnetic signal distribution of magnetic nanoparticles entering the reservoir by using an electrical measurement technology, and inverting the reservoir connectivity of the reservoir by resistivity;

The electromagnetic signal distribution of magnetic nanoparticles entering the reservoir was obtained by electrical logging technology. The fracture connectivity of the reservoir was inversed by resistivity, and the penetration curves of different peaks and trailers were obtained. The penetration curves were simulated and obtained by using the above equation, and the average residence time, recovery rate and fluid flow rate of the tracer agent were calculated, the simulation results of the fracture solute transport model were calibrated, and the flow path and permeability of fluid were evaluated.

Step 500, calibrating the simulated penetration curve with the really measured penetration curve, and fitting to obtain a concentrated parameter ø/b\sqrt{Dₘ}, which was represented by ΔC:

ΔC=ø/b\sqrt{Dₘ}

In the formula, φ is porosity, b is the half opening of the fracture, and Dm is dispersion coefficient of the tracer agent. φ is only associated with the core, Dm is only associated with the tracer agent, and b has the following relationship with the heat exchange area (SA/V) between water and rock in the fracture in unit volume (V):

SA/V=1/b

The fracture volume V can be obtained from the average residence time (τ) of the tracer agent curve:

V=Q*τ

In the formula, Q is the flow of the fluid in the core, and Q and τ can be obtained by a single tracer agent curve.

The resistivity distribution detected outside the core was compared with the penetration curve obtained by sampling observation, and the reservoir connectivity was comprehensively inversed and the heat exchange area was calculated.

As a preferred technical solution of the disclosure, in fracture connectivity evaluation and heat exchange area calculation of an EGS heat reservoir based on an electromagnetic signal, electromagnetic signal measurement was performed by using the induced polarization imaging technology to respectively monitor three tracer agents in real time, the change in the imaginary part of core complex resistivity over time was calculated, and the change was compared with the results of the penetration curve for analysis.

For evaluation of fracture connectivity, the resistivity and polarizability of the core were calculated in real time by using the Cole-Cole parameter inversion method of Marquette algorithm, the resulting resistivity and polarizability were compared with the initial resistivity and polarizability of the core, the change value of resistivity was calculated, and the parameters such as porosity and permeability of the core were obtained.

For the calculation of heat exchange area, parameters such as penetration time, porosity and permeability were calculated based on the real-time monitoring results of core geophysics real-time monitoring results, the fracture aperture and diffusion coefficient were given in the fracture solute transport model, and the change in the imaginary part of complex resistivity over time was fitted, and the heat exchange area was calculated.

Compared with the prior art, the disclosure has the following advantages:

(1) The disclosure adopts a method of combining an indoor test and a mathematical model and meanwhile is based on the established EGS project site data, magnetic nanoparticles are used as the tracer agents, the wild geological conditions are simulated through an indoor high-temperature high-pressure reactor test, different temperatures and pressures are given, surface modifying agents with significant differences in diffusivity and adsorptivity are selected to perform surface modification on magnetic nanoparticles, and the change in particle size and diffusivity is measured, thereby selecting the surface modifying agent to solve the problems of thermal stability and adsorptivity of magnetic nanoparticles.

(2) In the disclosure, the conserved tracer agent NaCl is combined with the adsorption tracer agent Safraine T to establish an indoor test platform for tracer agent test; the medium connectivity is inverted by using the electromagnetic signal with relatively low monitoring cost, the resistivity distribution detected outside the core is compared with the penetration curve obtained by sampling observation to integrate the inverted reservoir connectivity and calculate the effective heat exchange area between injected water and rock.

(3) In the disclosure, performance exhibition of the magnetic nanoparticle as the tracer agent at high temperature and high pressure is analyzed through the indoor core penetration test, a quantitative analysis method for key production parameters such as fracture aperture, connectivity and heat exchange area is established to obtain a new understanding of the magnetic nanoparticles tracer agent technology, and a new method for explaining the fracture connectivity in the reservoir by using the electromagnetic imaging technology provides a new technical means for future geothermal energy development.

The specific embodiments of the disclosure are described above. It should be understood that the disclosure is not limited to the above specific embodiments, and those skilled in the art can make various deformations or modifications within the scope of the claims, which does not affect the essence of the disclosure.

What is claimed is:

1. An Enhanced Geothermal System (EGS) magnetic nanoparticle tracer agent technique and interpretation method, comprising the following steps:
Step 100, accomplishing selection and preparation of a magnetic nanoparticle tracer agent;
Step 200, performing an indoor core penetration test by using three tracer agents namely a magnetic nanoparticle tracer agent prepared in Step 100, a conserved tracer agent NaCl and a reactive tracer agent Safraine T, detecting an electromagnetic signal using an exciting electrode, performing inversion calculation on a real component, an imaginary component and polarizability of complex resistivity, and then calculating the porosity of the core;
Step 300, characterizing EGS connectivity by sampling and analyzing the change in concentration of magnetic nanoparticles, obtaining penetration curves of different peaks and trailers through a tracer agent test, respectively fitting the penetration curves using a mathematical model, and constructing a fracture solute transport model;
Step 400, obtaining electromagnetic signal distribution of magnetic nanoparticles entering into a reservoir by utilizing an electrical measurement technology, and inverting the reservoir connectivity by using resisitivity; and
Step 500, comparing resisitivity distribution detectiond outside the core with the penetration curve observed by sampling, comprehensively inverting the reservoir connectivity and calculating the heat exchange area.

2. The EGS magnetic nanoparticle tracer agent technique and interpretation method according to claim 1, wherein the Step 100 specifically comprises the following steps: the magnetic nanoparticles modified by a surface modifying agent are placed in a high-temperature high-pressure reactor, field stable temperature-pressure conditions of an EGS are given, concentration change and experience change of a magnetic nanoparticle tracer agent solution are measured so as to obtain a change relationship depending on temperatures and pressures, thereby screening an optimal surface modifying agent.

3. The EGS magnetic nanoparticle tracer agent technique and interpretation method according to claim 2, wherein the screening specifically comprises the following steps:
Step 101, surface modification of magnetic nanoparticles, namely, preparing a certain concentration of a copolymer solution of sulfonated polystyrene and malonic acid, SiO₂ modified magnetic nanoparticles and magnetic ferritin nanoparticles;
Step 102, stable pressure sensitivity analysis of magnetic nanoparticles, namely, designing a high-temperature high-pressure reactor test, and analyzing a change relationship of a particle size depending on temperatures and pressures to initially select magnetic nanoparticles meeting performances; and
Step 103, selection of high-temperature high-pressure diffusivity, namely, simulating reservoir conditions, displacing a tracer agent through high pressure, and determining influences of different surface modifying agents on adsorptivity and diffusivity of magnetic nanoparticles in pores through a high-pressure displacement tracer agent, thereby preferably selecting high-diffusivity magnetic nanoparticles as an ideal tracer agent.

4. The EGS magnetic nanoparticle tracer agent technique and interpretation method according to claim 1, wherein the Step 200 specifically comprises the following steps: the tracer agents, such as a tracer agent NaCl, a tracer agent Safraine T and a magnetic nanoparticle tracer agent, are monitored in real time respectively using an induced polarization imaging technology, the change in an imaginary part of complex resistivity of the core over time is calculated, a core penetration test result is analyzed by comparing the change with a penetration curve result, penetration time and fracture volume are calculated, the fracture aperture, diffusivity and core porosity parameters are given in a fracture solute transport model, penetration curves of different peaks and trailers are fit, and heat exchange areas are calculated.

5. The EGS magnetic nanoparticle tracer agent technique and interpretation method according to claim 1, wherein,
the Step 400 specifically comprises the following steps: real-time distribution detection of magnetic nanoparticles is realized through an electromagnetic imaging technology, which reduces monitoring cost; and a monitoring means is innovated to replace sampling observation with physical geography detection, and the heat exchange area of the reservoir is calculated through mathematic inversion.

6. The EGS magnetic nanoparticle tracer agent technique and interpretation method according to claim 1, wherein the Step 500 specifically comprises the following steps: medium connectivity is inverted by utilizing an electromagnetic signal, the resistivity distribution detected outside the core is compared with the penetration curve obtained by sampling observation to integrate the inverted reservoir connectivity and calculate an effective heat exchange area between injected water and rock.

7. The EGS magnetic nanoparticle tracer agent technique and interpretation method according to claim 1, wherein,
in the Step 400, inverting reservoir connectivity by using resisitivity is specifically as follows: the resistivity and polarizability of the core are calculated in real time utilizing a Cole-Cole parameter inversion method of a Marquette algorithm, and the calculated resistivity and polarizability are compared with the initial resistivity and polarizability of the core, so that the change value of resistivity is calculated, and the porosity and permeability parameters of the core are obtained.

8. The EGS magnetic nanoparticle tracer agent technique and interpretation method according to claim 1, wherein,
in the Step 200, the penetration time and the fracture volume are calculated according to the test results obtained from an indoor core penetration test, the fracture aperture, diffusivity, core porosity and other parameters are given in the fracture solute transport model, the penetration curves of different peaks and trailers are fit, and the heat exchange areas are calculated.

9. The EGS magnetic nanoparticle tracer agent technique and interpretation method according to claim 1, wherein,
in the Step 200, the inversion calculation is specifically as follows: the medium connectivity is inverted by utilizing an electromagnetic signal, the resistivity distribution detected outside the core is compared with the penetration curve obtained by sampling observation to integrate the inverted reservoir connectivity and calculate the heat exchange area between injected water and rock.

10. The EGS magnetic nanoparticle tracer agent technique and interpretation method according to claim 1, wherein in the Step 500, the penetration time and the fracture volume are calculated based on core penetration test results, the fracture aperture, diffusivity, core porosity and other parameters are given in the fracture solute transport model, the penetration curves of different peaks and trailers are fit, and the heat exchange areas are calculated; the medium connectivity is inverted by utilizing the electromagnetic signal, and the resistivity distribution detected outside the core is compared with the penetration curve obtained by sampling observation to integrate the inverted reservoir connectivity and calculate the heat exchange area between injected water and rock.
